(19) United States
(12) Patent Application Publication
(10) Pub. No.: US 2026/0132479 A1
(43) Pub. Date: May 14, 2026

(54) Cleaner extraction of target materials from a resource

(71) Applicants: Jinichiro Nakano, Albany, OR (US); Anna Nakano, Albany, OR (US)

(72) Inventors: Jinichiro Nakano, Albany, OR (US); Anna Nakano, Albany, OR (US)

(21) Appl. No.: 18/831,908

(22) Filed: Nov. 4, 2025

Related U.S. Application Data
(60) Provisional application No. 63/719,112, filed on Nov. 12, 2024.

(51) Int. Cl. C22B 1/00; B09B 3/80; B09B 5/00; B09B 101/55

(52) U.S. Cl. CPC C22B 1/005; B09B 3/80; B09B 5/00; B09B 2101/55

(57) ABSTRACT

A cleaner process of extracting a target material from a resource without requiring additives, roasting, firing, heating, acid leaching, and base leaching, by separating the resource by group per characteristic category using a unique concentration ratio, and removing the target material. In the process, the resource may undergo at least one beneficiation stage and at least one separation stage, following the grouping step. The target material may be extracted as a concentrate.

### CROSS-REFERENCE TO RELATED APPLICATION

This application claims the priority benefit of U.S. Provisional Patent Application Ser. No. 63/719,112 filed Nov. 12, 2024, incorporated herein by reference in its entirety.

### BACKGROUND OF THE INVENTION

As human activities and development further continue, more materials are consumed for construction and manufacturing. Raw materials in general come from excavation of the earth with the limited quantities from recycling of spent materials or waste. With environmental concerns receiving more attentions from mining and landfilling, beneficiation of waste byproduct such as slag and ash from industries such as metallurgical plants, power plants, gasification facilities, boilers, and smelting factories can enable cleaner material production if the extraction or concentration of such a material could be performed in an environmentally benign and economical fashion.

Currently, most of the extraction or concentration processes practiced in the waste beneficiation often involves additives, roasting, firing, heating and acid/base leaching, generating large quantities of hazardous waste and requiring high energy consumption. It is therefore beneficial to provide a novel method to extract or concentrate valuable materials from waste resources to reduce current environmental and economical burdens to enable cleaner material beneficiation from waste resources.

### BRIEF SUMMARY OF THE INVENTION

This invention relates to a method and a system for extracting or concentrating materials (inclusively ‘extracting’ hereafter) from a resource including byproduct or waste such as slag, ash, residue, rejects, clinker, soot, dross, tailings, electronic waste, etc. (‘byproduct’ hereafter). Natural minerals, ores, or its mixture with waste byproduct may be used as a resource instead of the waste byproduct alone. The slag, ash, soot, and clinker may be generated by processes of, for example, metallurgical plants, power plants, gasification facilities, boilers, and smelting factories.

Target materials to be extracted by this invention may include, but not limited to, Li, C, Na, Mg, aluminosilicate, calcium aluminosilicate, silicate, silica, Al, Si, P, S, K, Ca, Ti, V, Cr, Fe, Co, Ni, precious metals, rare earth elements, Th, and U.

This invention enables cleaner extraction of at least one target material or generation of a concentrate of at least one target material from a resource without requiring additives, roasting, firing, heating, acid leaching, and base leaching.

In some embodiment, the invention operates at room temperature in ambient pressure. In some embodiment, the invention operates without using solid additives, chemical agents, acid solutions, or base solutions. In some embodiment, the invention operates without heating the resource at any stage of the extraction process.

To demonstrate the invention, laboratory testing with synthetic slags simulating industrial gasification slag containing approximately 1-2 wt. % V, 0.5-1 wt. % Ni, 10-20 wt. % Si, 0.5-1.5 wt. % Fe, and 0.5-1.5 wt. % Ca with the remainder being C (<70 wt. %), was conducted. Each slag sample was subjected to first size separation into groups with various sizes. Then, a unique range group having a ratio of metals to volatiles (i.e., (V+Ni+Fe)/(C+S)=12) larger than a preset value of 1, was identified. The identified range group was then ground to below 1 mm, followed by magnetic separation with Nd magnets, further to below 500 microns, and further magnetic separation with Nd magnets. Three distinct concentrates were collected from the process and chemically analyzed by X-ray energy dispersive spectrometry. Resulting concentrations of Ni, V, and C in each concentrate generated from the test were presented in TABLE 1.

TABLE 1
Concentrations of target materials (Ni, V, C) in three
resulting concentrates generated by this invention.

| | Concentrate 1 | Concentrate 2 | Concentrate 3 |
|---|---|---|---|
| | (wt. %) | (wt. %) | (wt. %) |
| Samples | Ni | V | C |
| Slag 1 | 59.8 | 29.5 | >90 |
| Slag 2 | 52.3 | 22.3 | >90 |
| Slag 3 | 41.9 | 31.5 | >90 |
| Slag 4 | 43.4 | 21.1 | >90 |
| Slag 5 | 48.3 | 27.2 | >90 |

### BRIEF DESCRIPTION OF THE DRAWINGS

FIG. 1: Embodiment 1 where the process comprises category grouping, parameter screening, and target material separation.

FIG. 2: Embodiment 2 where the process comprises category grouping, parameter screening, target material separation, and step repetition.

### DETAILED DESCRIPTION OF THE INVENTION

The disclosed process will become better understood by reviewing the following detailed description in conjunction with the figure. The detailed description and figure provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

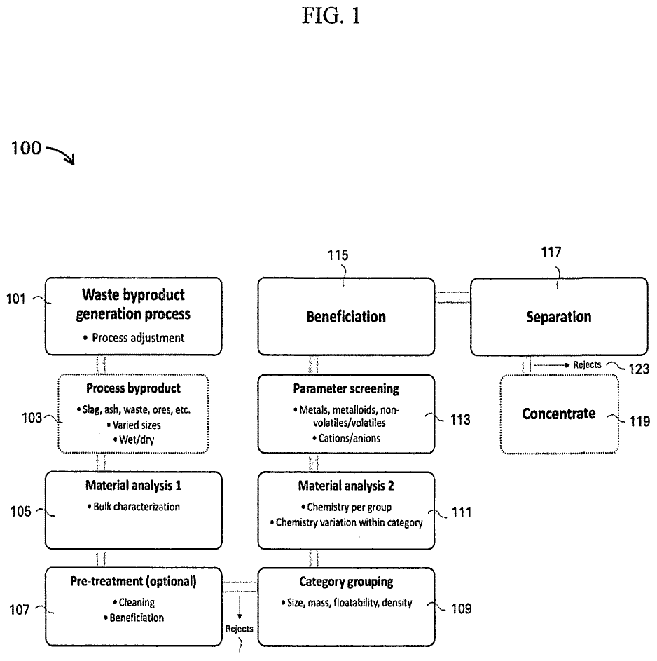

The process illustrated in FIG. 1 can be operated either as a batch process or a continuous process. The process (100) to concentrate a target material as applied to process byproduct such as slag is illustrated in FIG. 1 where waste byproduct is a resource.

A resource, i.e., Process byproduct (103) such as slag may be generated by any resource generation process, i.e., Waste byproduct generation process (101) including metallurgical processes, gasification processes, and smelting processes. Waste byproduct generation process (101) may be adjusted by modifying process temperature, pressure, or residence time to preset values, or fluxing with a chemical agent as required. Process byproduct (103), which may be granulated at exit by, for example, air or water quenching, may exist in various particle sizes spanning from nanometers to centimeters. Process byproduct (103) may be wet or dry. In this invention, process byproduct (103) may be provided directly from waste byproduct generation process (101) or provided after any conventional beneficiation processing, which may promote overall mineral separation, size breakdown, and/or pulverization. Conventional beneficiation processing may include grinding, milling, gravity, density, frictional, size, flotation, bubble, vibration, magnetic techniques, or any combination thereof, which may be performed wet or dry. Process byproduct (103) may be industrial ash or in some embodiment it may be natural minerals or ores.

Once the process byproduct (103) is provided, the process byproduct (103) undergoes Material analysis 1 (105) where bulk material is characterized by chemistry, mineralogy, moisture content, sulfur content, and carbon content.

Optionally, the process byproduct (103) may be pretreated by cleaning any residues from the previous processes or in some embodiment, by beneficiating any non-target materials (107). Any materials that do not sufficiently contain the target material are rejected (121).

The process byproduct (103) then undergoes Category grouping (109) where the process byproduct (103) is tested for at least one of predetermined characteristic categories including size, mass, floatability, and density. The process byproduct (103) is then separated into at least two groups with different ranges within each characteristic category. For example, as for the size category, the process byproduct (103) may be separated into three different size range groups: <100 um, 100 um-500 um, and >500 um.

The process byproduct (103) separated into at least two groups within each characteristic category at step (109), are then chemically analyzed at Material analysis 2 (111) for each group per category and a unique ratio of concentration of metals and metalloids to that of volatiles (‘Ratio’ hereafter) is determined per group. The metals may include alkali metals, alkaline earth metals, and transition metals. The alkali metals may be, but not limited to Li, Na, K, or any combination, alkaline earth metals may be, but not limited to Mg, Ca, Sr, or any combination, and transition metals may be, but not limited to Cr, V, Ni, Fe, Co, or any combination. The metalloids may be, but not limited to, B, Si, or any combination. Volatiles may be nonmetals including, not limited to, C, S, P, or any combination. For example, if a particular group contains 4.5 wt. % Ni, 0.5 wt. % Na as metals, 25% wt. % Si as a metalloid, and 70 wt. % C as a volatile, the Ratio would be determined as (4.5+0.5+25)/70=0.43.

In some embodiment, the Ratio is the metals/the volatiles.

In some embodiment, the Ratio is the transition metals/the volatiles.

In one embodiment, the Ratio is non-volatiles/volatiles. The non-volatiles may be any elements other than the volatiles.

In one embodiment, the Ratio is cations/anions where cations are at least one positive ion such as Fe2+, Fe3+, A13+, Cr3+, Ni+, V5+, V3+ in the process byproduct (103) and anions are at least one negative ion such as O2− in the process byproduct (103).

In one embodiment, the Ratio is the ratio of atoms that tend to be positive ions/those that tend to be negative.

In some embodiments, the Ratio is the sum of at least two ratio definitions mentioned above. For example, if a particular group contains 4.5 wt. % Ni, 0.5 wt. % Na as metals, 25% wt. % Si as a metalloid, and 70 wt. % C as a volatile, the Ratio would be determined as the sum of two ratio definitions: metals and metalloid to volatile, and metals to volatile. That is, (metals+metalloid)/(volatile)+ (metals+metalloid)/(volatile)=(4.5+0.5+25)/70+ (4.5+0.5)/70=0.5.

In one embodiment, the Ratio may controlled at the waste byproduct generation process stage (101) by, for example, fluxing, additives, temperature, pressure, or feed chemistry, residence time of feed, reaction time of feed in a vessel, vessel geometry, interaction with refractory liner, or a combination thereof.

At least one range group of the process byproduct (103) from Material analysis 2 (111) that has the Ratio greater than or equal to a preset value is then identified and removed at Parameter screening (113). Such range groups may be identified or selected by any of the categories or all of the categories. In one embodiment, a group or more of the identified range group may have the lowest or low volatile concentration.

In one embodiment, a particle group identification is limited or further limited by a preset value of a concentration of the volatiles.

In one embodiment, the range group identification is limited or further limited by a preset value of at least one of the characteristic categories.

In one embodiment, the range group identification may be conducted by the presence of a kink, a break, or a sudden jump or drop on or out of the trend in Ratio variations over the entire range within each category. For example, as for the size category, while the Ratio changes smoothly along certain size values or over a certain size range, but beyond some point, the Ratio abruptly jumps. The range group that falls beyond this point would be identified in the size category. The abrupt change may be simply determined by an abrupt change in the slope of a trend (or best fit) line or curve.

In one embodiment, a kink, a break, or a sudden jump or drop is determined by a change in the first derivative or the second derivative of a trend line of the Ratio per each category, which may become larger than a preset uncertainty range (magnitude or percent).

In some embodiments, the range group identification may be performed by requiring to satisfy a preset value for each of at least two characteristic categories. In this case, the range group to be identified must meet all of the preset values for all the characteristic categories. For example, if size and density are required as characteristic categories, the range group must satisfy the preset values of both characteristic categories at the same time.

The formed, separated, removed, collected, extracted, or concentrated Process byproduct (103) may contain minerals such as carbide, sulfide, phosphide, carbonate, sulfate, phosphate, metals, alloys, oxide, or combination of thereof. In one embodiment, types, quantities, or concentrations of such minerals may be controlled at the Waste byproduct generation process stage (101) by, for example, fluxing, additives, temperature, pressure, or feed chemistry, residence time of feed, reaction time, vessel geometry, interaction with refractory liner, or a combination thereof.

The identified group of the process byproduct (103) removed at Parameter screen (113) then undergoes at least one Beneficiation stage (115) where the identified group is treated by any conventional beneficiation techniques including, but not limited to, crushing, grinding, pulverization, stomping, or any combination thereof.

The identified group after the Beneficiation (115) then undergoes Separation stage (117) where mineral separation is performed to remove at least one target material as a Concentrate (119) by any conventional beneficiation processes including, but not limited to, gravity, density, frictional, size, flotation, bubble, vibration, magnetic techniques or any combination thereof, which may be conducted wet or dry. The remaining material or Reject (123) after the Separation (117) is rejected. The target material may contain at least one target element.

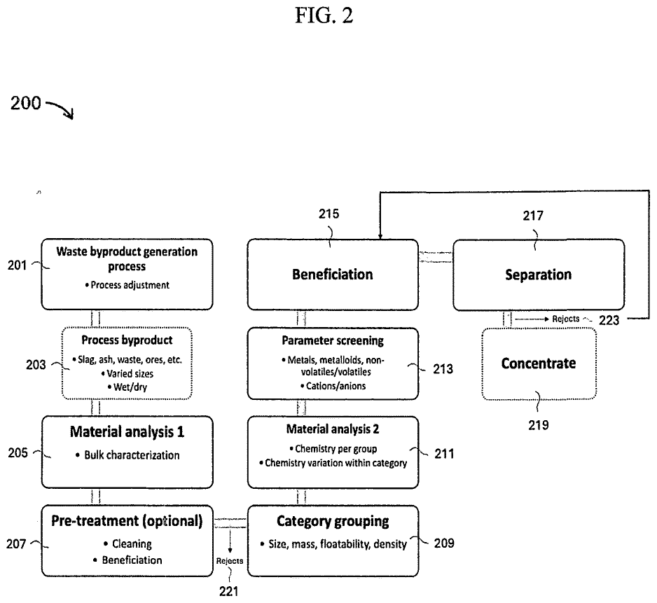

Another embodiment of this invention where a part of the process is repeated to generate another concentrate is illustrated in FIG. 2. In this embodiment, the rejected materials (223) is recycled to the Beneficiation stage (215) where the Reject (223) is merged with the screened material from the Parameter screening stage (213) to improve the yield. In another embodiment, the Reject (223) may be recycled to the Beneficiation stage (215) where the Reject (223) is not merged with the screened material from the Parameter screening stage (213) but processed independently. In some embodiments, any part of the steps may be repeated until satisfactory outcome is reached.

1. A method for extracting a target material from a resource, comprising:
i. providing a resource containing at least one target material;
ii. undergoing category grouping where the resource is separated into range groups for at least one predetermined characteristic category;
iii. chemically analyzing each range group per characteristic category;
iv. identifying at least one unique range group that has a ratio of metals and metalloids to volatiles equal to or greater than a preset value;
v. applying at least one beneficiation technique to the identified group; and
vi. applying at least one separation technique to remove the target material.

2. The method in claim 1, where the resource is byproduct, waste, natural minerals, ores, or any mixture thereof.

3. The method in claim 1, where the range group identification may be performed by requiring satisfying a preset value for each of at least two characteristic categories.

4. The method in claim 1, where the target materials is removed as a concentrate.

5. The method in claim 1, where the method further comprises a resource generation process that generates the resource, which can be adjusted by fluxing, additives, temperature, pressure, or feed chemistry, residence time of feed, reaction time, vessel geometry, interaction with refractory liner, or a combination thereof.

6. The method in claim 1, where the ratio is a ratio of metals to volatiles.

7. The method in claim 1, where the ratio is a ratio of transition metals to volatiles.

8. The method in claim 1, where the ratio is a ratio of non-volatiles to volatiles.

9. The method in claim 1, where the ratio is a ratio of cations to anions.

10. The method in claim 1, where the ratio is the sum of at least two ratio definitions.

11. The method in claim 1, where the range group identification is conducted by the presence of a kink, a break, or an abrupt change on or out of the trend in ratio variations over the entire range within each characteristic category.

12. The method in claim 1, where any part of the steps is repeated until satisfactory outcome is reached.

13. The method in claim 1, where the method operates at room temperature and in an ambient pressure.

14. The method in claim 1, where the method operates without additives, roasting, firing, heating, acid leaching, base leaching, or any combination thereof.

15. A method for extracting a target material from a resource, comprising:
i. a mechanism for providing a resource containing at least one target material;
ii. a mechanism for undergoing category grouping where the resource is separated into range groups for at least one predetermined characteristic category;
iii. a mechanism for chemically analyzing each range group per characteristic category;
iv. a mechanism for identifying at least one unique range group that has a ratio of metals and metalloids to volatiles equal to or greater than a preset value;
v. a mechanism for applying at least one beneficiation technique to the identified group; and
vi. a mechanism for applying at least one separation technique to remove the target material.
